(19) United States
(12) Patent Application Publication
(10) Pub. No.: US 2024/0282342 A1
(43) Pub. Date: Aug. 22, 2024

(54) TIME-LAPSE IMAGING SYSTEMS AND METHODS

(71) Applicant: Bloomsie Corporation, New York, NY (US)

(72) Inventors: Michael Jay BAKER, New York, NY (US); Quinn Blinkhorn COOPER, New York, NY (US)

(21) Appl. No.: 18/569,367

(22) PCT Filed: Jun. 10, 2022
(86) PCT No.: PCT/US2022/072880

§ 371 Date: Dec. 12, 2023

Related U.S. Application Data
(60) Provisional application No. 63/212,393, filed on Jun. 18, 2021.

(51) Int. Cl. G11B 27/031

(52) U.S. Cl. CPC G11B 27/031

(57) ABSTRACT

A time-lapse imaging system is provided that may include an image capture device, an intervalometer coupled to the image capture device for controlling an interval at which the image capture device captures an image of one or more objects, and a computing device including a processor. Using a plurality of images captured by the image capture device, the processor may combine the plurality of images and a selected audio file into a first file. The processor then stores the first file in a non-transitory, machine readable storage medium. One or more users may then select, via a network, a second file (e.g., an electronic greeting card) for the processor to pair with the first file. The second file and a link to the first file may then be transmitted to one or more recipient devices via the network.

### CROSS-REFERENCE TO RELATED APPLICATION

This application claims the benefit of priority to U.S. Provisional Patent Application No. 63/212,393, filed on Jun. 18, 2021, the entire disclosure of which is expressly incorporated herein by reference in its entirety.

### BACKGROUND

Traditionally, electronic card templates are created and uploaded to a company's website where customers' may select an electronic greeting card to send to a recipient (e.g., a family member, a friend, a colleague, etc.). Sending an electronic card and hyperlink to a time-lapse video to one or more recipients, may allow one or more users to make one or more selections indicating an audio recording to be synchronized with a time-lapse video and an electronic card to be paired with the synchronized time-lapse video.

### SUMMARY

In some examples, a system may include an image capture device, an intervalometer coupled to the image capture device for controlling an interval at which the image capture device captures an image of one or more objects, and a computing device including a processor. The processor may be configured to combine a plurality of images captured by the image capture device and a selected audio file into a first file. The processor may also be configured to store the first file in a non-transitory, machine-readable storage medium.

In other examples, a method may include receiving a plurality of images from an image capture device coupled to an intervalometer. Once the plurality of images are received, the plurality of images and a selected audio file may be combined into a first file. The method may include saving the first file in a cloud server and storing the first file's location in the cloud server in a database that is accessible via a network. The method may include pairing the first file with a second file indicated by one or more user selections received via the network and then transmitting the second file and a link to the first file to one or more recipient devices via the network.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of one example of an imaging system in accordance with some embodiments.

FIG. 2 is a flow diagram of one example of a method of sending an electronic card and hyperlink to a time-lapse video to one or more recipients in accordance with some embodiments.

FIG. 3 is a high-level flow chart of one example of a method of sending an electronic card and hyperlink to a time-lapse video to one or more recipients in accordance with some embodiments.

FIG. 4 is a block diagram of the functional components of one example of a computing device in accordance with some embodiments.

FIG. 5 is a flow diagram of one example of a method that can be performed by a computing device in accordance with some embodiments.

FIG. 6a is a flow diagram of one example of a method of storing a first file in a database that is accessible via a network of FIG. 5 in accordance with some embodiments.

FIG. 6b is a high-level flow chart of one example of a method of storing a first file in a database that is accessible via a network of FIG. 5 in accordance with some embodiments.

### DETAILED DESCRIPTION

This description of the exemplary embodiments is intended to be read in connection with the accompanying drawings, which are to be considered part of the entire written description.

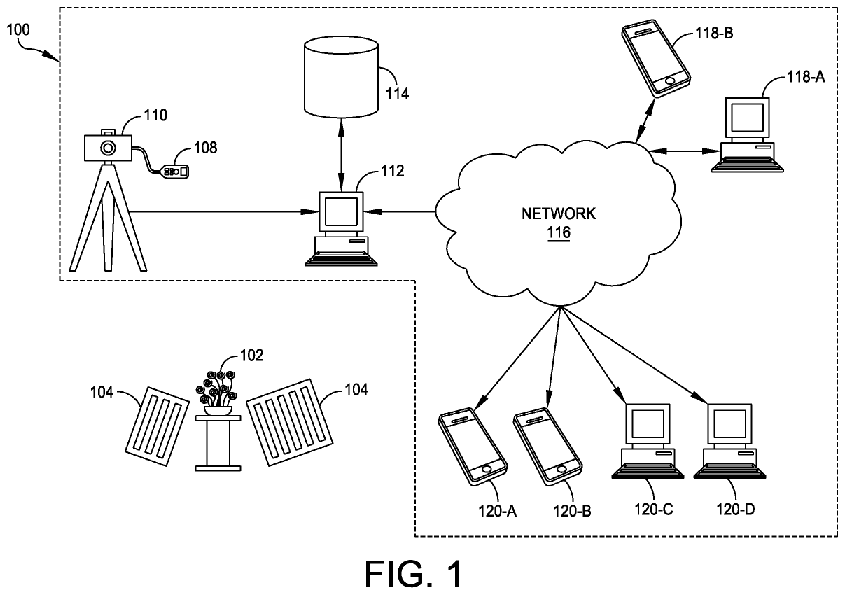

FIG. 1 shows one example of an imaging system 100. The imaging system 100 may include a camera 110 with an intervalometer 108. The camera 110 with an intervalometer 108 may be used to capture images of a floral arrangement 102 surrounded by grow lights 104 at a predetermined interval. In some embodiments, the camera 110 may be a DSLR or mirrorless camera. The intervalometer 108 may be in the camera 110, on an app that is connected wirelessly to the camera 110, or a physical intervalometer that is connected to the camera by a wire, as shown in FIG. 1. Grow lights 104 may be used to mimic sunlight and may be positioned around the floral arrangement 102 while images are taken. Grow lights 104 may be positioned between 6 inches and 10 feet from the floral arrangement 102. To encourage blooming, the room in which the floral arrangement 102 is photographed may have an ambient temperature between 40° F and 110° F. However, it should be understood that other ambient temperatures may be used depending on the type of flowers are to be photographed or imaged.

The images taken by camera 110 may be transferred to computing device 112, and a time-lapse video may be generated using the images. Computing device 112 may be operably coupled (e.g., via a wired or wireless coupling) to a database 114. In some embodiments, database 114 may store one or more audio recordings that the computing device 112 may sync with the time-lapse video. In some embodiments, the one or more audio recordings may not be uploaded to the database 114 by a user, but, rather, the user may select the one or more audio recordings from a short, curated list on the database 114. In some embodiments, database 114 may store electronic cards that the computing device 112 may attach to the time-lapse video. In some embodiments, the electronic cards may be one or more of greeting cards or invitations. It should be understood that the database 114 may be a distributed database in which data is stored in multiple different physical locations. The database may be a relational database (e.g., RDB), a key value or object store (e.g., Berkeley DB, GNU dbm, NoSQL, S3), or any other suitable storage device that facilitates the storage and retrieval of data.

Computing device 112 may be connected to one or more user devices 118-A, 118-B through network 116. In some embodiments, network 116 may be the Internet, and the one or more user devices 118-A, 118-B are online. “Online” may mean connecting to or accessing source data or information from a location remote from other devices or networks coupled to the Internet. In some embodiments, computing device 112 may be connected to one or more recipient devices 120-A, 120-B, 120-C, 120-D through network 116. In some embodiments, the one or more recipient devices 120-A, 120-B, 120-C, 120-D may be online.

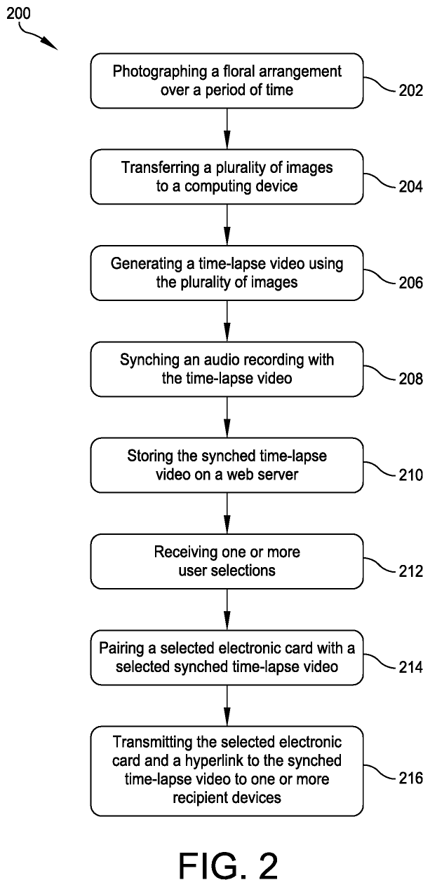

FIG. 2 is a flow diagram of one example of a method 200 of sending an electronic card and time-lapse video to one or more recipients. At block 202, the camera 110 may obtain one or more images (e.g., photograph) a floral arrangement 102 over a period of time. In some embodiments, images of the floral arrangement 102 may be shot in intervals ranging between 1 and 600 seconds. It should be understood that the interval and period of time may change and be suitable to capture a flower blooming. In some embodiments, the period of time may be between 24 and 240 hours.

At block 204, a plurality of images taken at camera 110 may be transferred to computing device 112. To capture the plurality of images taken at camera 110, a memory chip (e.g., a Secure Digital card) may be used to store (e.g., temporarily) the plurality of images. The memory chip, which may store the plurality of images in a particular format (e.g., RAW or JPEG, to list only a few possibilities), may be connected to the computing device 112 where the plurality of images are copied to a file. It should be understood that the images may be obtained directly from the camera 110 by a computing device 112 (e.g., through a wired or wireless connection) and thus the transfer may be performed automatically when the images are obtained. In some embodiments, the camera may be integrated into the computing device 112 as will be understood by one of ordinary skill in the art. In some embodiments, the plurality of images may be saved on an external hard drive, on computing device 112, or in the cloud.

At block 206, the computing device 112 may generate a time-lapse video using the plurality of images (e.g., a time-lapse video showing an arrangement of roses blooming). The time-lapse video may be created automatically by using a first program/software (e.g., LRTimelapse paired with Adobe Lightroom Classic, Timelapse Workflow, Panolpase, etc.) running on computing device 112. As will be understood by those of ordinary skill in the art, the software may string together a number of images or pictures. In some embodiments, the number of pictures may be in a range of no less than 1,000 and no more than 60,000 pictures.

The time-lapse video may be uploaded or otherwise provided to a second program/software (e.g., Adobe Premiere Pro, Final Cut Pro, etc.), which may be running the same or different computing device 112. The second program/software may enable editing of the time-lapse video. Examples of the editing including, but are not limited to, color adjustment, exposure, and/or slowing down or speeding up portions of the video, to list only a few possibilities.

The time-lapse video may be stored in database 114 and served up by a web server, which may have access to database 114. It should be further understood that the web server may include plural web servers each with access to one or more databases as will be understood by one of ordinary skill in the art. Further, as used herein, a web server may be configured as a web server that serves up web pages in response to a user or may be implemented as an email server in which a file, which may be compressed, is transmitted to a user as an email. In some embodiments, an operator (e.g., an administrator of the service using computing device 112, for example) may replay and edit the time-lapse video to achieve desired length of video.

At block 208, a computing device 112 may synchronize an audio recording with the time-lapse video. Database 114 may store audio recordings from a short, curated list of audio recordings, and the computing device 112 may use a stored audio recording from database 114. In some embodiments, a user may select the audio recording to be synchronized with the time-lapse video.

At block 210, the computing device 112 may store the synchronized time-lapse video on a web server, such that the synchronized time-lapse video is made available for viewing and selection on a website. It should be understood that that web server may run on the computing device 112 or another computing device, which may be the same computing device or a different computing device that includes the database 114. The website may display a plurality of synchronized time-lapse videos. In some embodiments, the plurality of videos may show different varieties of flowers blooming. Users may access the website on user devices 118-A, 118-B and select one of the plurality of synchronized time-lapse videos to send to one or more recipients (e.g., the user's mother and the user's mother-in-law). Users may also select an electronic card (e.g., a card that says “Happy Mother's Day!”) to pair with the synchronized time-lapse video.

At block 212, the computing device 112 may receive one or more user selections (e.g., the selected synchronized time-lapse video, the selected electronic card, and the selected one or more recipients).

At block 214, the computing device may pair the selected electronic card with the selected synchronized time-lapse video.

At block 216, the selected electronic card and a hyperlink to the synchronized time-lapse video may be transmitted to one or more recipient devices 120-A, 120-B, 120-C, 120-D. In some embodiments, the electronic card may be a hyperlink that a recipient can click on to access the synchronized time-lapse video. In some embodiments, the electronic card may contain a link to the synchronized time-lapse video. In some embodiments, the user may email or text the selected electronic card and a hyperlink to the synchronized time-lapse video to the recipient's device 120. In some embodiments, the user may provide the recipient's email and/or phone number on the website when making their card and video selections, and the computing device may email or text the selected electronic card and a hyperlink to the synchronized time-lapse video to the recipient's device 120. Once the recipient receives the text or email, the recipient may view and click on the electronic card, electronic envelope, image of bouquet, or link within the electronic card, and the recipient's device may open the website where the recipient can view the electronic card and the selected synchronized time-lapse video.

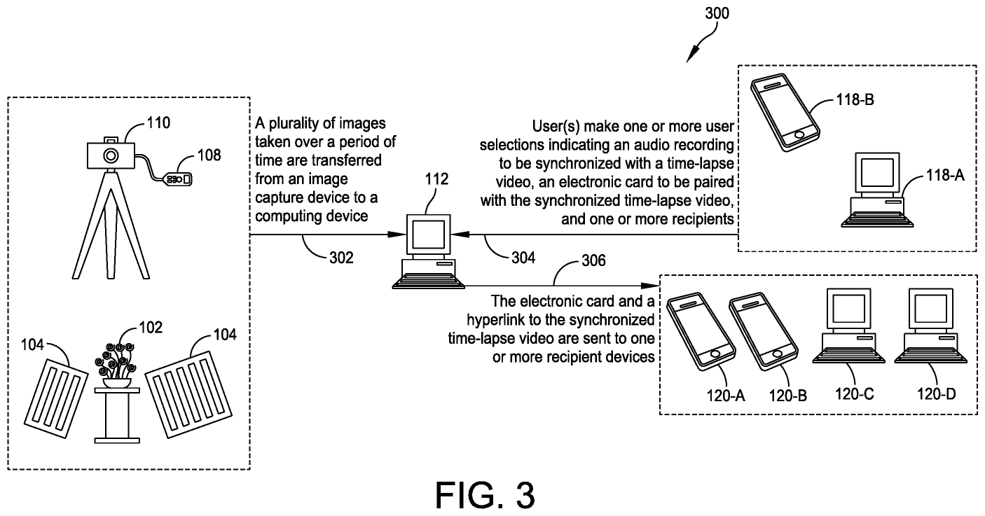

FIG. 3 is a high-level flow chart of one example of a method 300 of sending an electronic card and hyperlink to a time-lapse video to one or more recipients. FIG. 3 shows portions of imaging system 100; however, it should be understood that other imaging systems may be used to perform method 300.

At step 302, a plurality of images taken over a period of time may be transferred from an image capture device (e.g., camera 110) to a computing device (e.g., computing device 112), as described in detail above with respect to FIG. 2. In some embodiments, the image capture device 110 may have acquired images of a floral arrangement 102 over a period of time. In some embodiments, an operator (e.g., an administrator of the service using computing device 112, for example) may edit the plurality of images, and the computing device 112 may generate a time-lapse video using the plurality of images.

At step 304, one or more users may make one or more user selections indicating an audio recording to be synchronized with a time-lapse video, an electronic card to be paired with the synchronized time-lapse video, and one or more intended recipients. The one or more users may make these selections using user devices 118-A, 118-B, as described in detail above with respect to FIG. 2. Accordingly, the user selections may be received by a user device 118 and received by computing device 112. In some embodiments, computing device 112 may synchronize an audio recording with the time-lapse video in response to receiving the user input. In some embodiments, computing device 112 may pair an electronic card with the synchronized time-lapse video.

At step 306, the computing device 112 may send the electronic card and a hyperlink to the synchronized time-lapse video to one or more recipient devices 120-A, 120-B, 120-C, 120-D. In some embodiments, the computing device 112 may send the electronic card and a hyperlink to the synchronized time-lapse video via email. In some embodiments, a user may be able to email or text the electronic card and a hyperlink to the synchronized time-lapse video to recipient devices directly after being provided with a file by the computer device 112. In some embodiments, once the recipient receives and opens the email or text and clicks on the electronic card, they may be re-directed to a website to view the synchronized time-lapse video and electronic card.

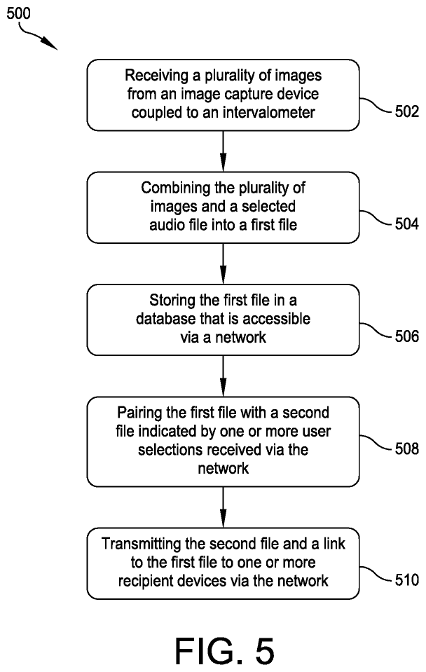

FIG. 5 is a flow diagram of one example of a method 500 that may be performed by a computing device (e.g., computing device 112). At block 502, the computing device 112 may receive a plurality of images from an image capture device (e.g., camera 110) coupled to an intervalometer (e.g., intervalometer 108). In some embodiments, the plurality of images may capture one or more flowers blooming, and the plurality of images may be captured by an image capture device (e.g., camera 110). The computing device 112 may automatically generate a time-lapse video using the plurality of images.

At block 504, the computing device 112 may combine the plurality of images (e.g., in the form of a time-lapse video) and an audio file (e.g., an audio recording) previously selected by one or more users into a first file. In some embodiments, the computing device 112 may synchronize the audio recording with the time-lapse video.

At block 506, the computing device 112 may store the first file in a database (e.g., database 114) that may be accessible via a network (e.g., network 116), which will be described in further detail below. In some embodiments, the computing device 112 may store the first file on a web server. In some embodiments, the computing device 112 may receive one or more user selections (e.g., the selected synchronized time-lapse video, the selected electronic card, and the selected one or more recipients).

At block 508, the processor on computing device 112 (e.g., processor(s) 402) may pair the first file with a second file indicated by one or more user selections received via the network 116. In some embodiments, the second file may comprise an electronic card.

At block 510, the processor on computing device 112 (e.g., processor(s) 402) may cause the second file and a link to the first file to be transmitted to one or more recipient devices via the network.

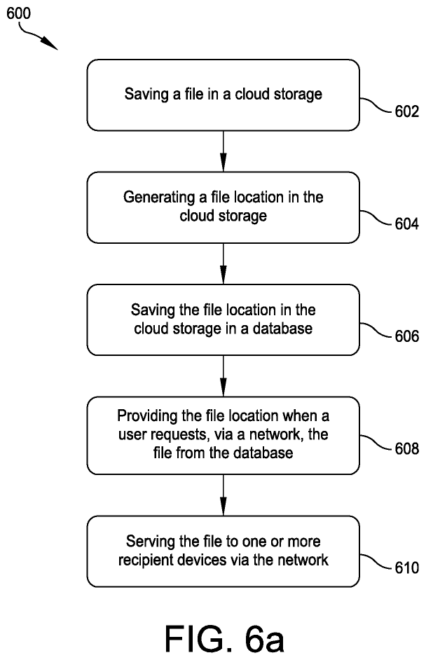

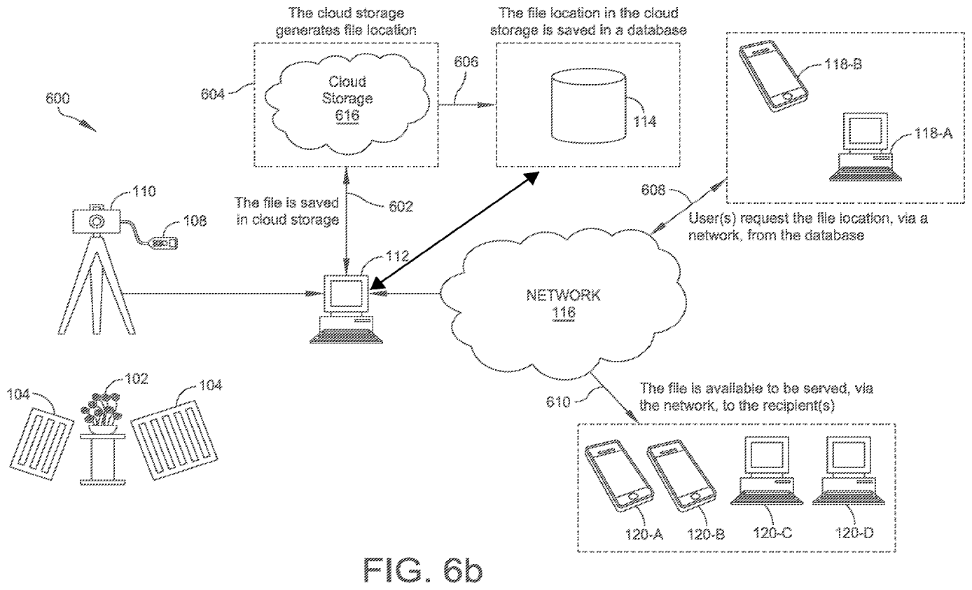

FIGS. 6a and 6b are a flow diagram and a high-level flow chart, respectively, of one example of a method of storing a first file in a database that is accessible via a network. In particular, FIG. 6a illustrates one example of detailed steps of block 506 of FIG. 5. Additionally, FIG. 6b shows portions of imaging system 100, although one of ordinary skill in the art will understand that other imaging systems may be used.

At block 602, after a computing device, such as computing device 112 described above with respect to FIG. 2, combines a plurality of images (e.g., floral arrangement 102) and an audio file (e.g., an audio recording) into a file as described above with respect to block 504 of FIG. 5, the file may be saved in a cloud server (e.g., cloud storage 616, Amazon Web Services, Microsoft Azure, etc.).

At block 604, the cloud storage 616 may generate a file location. In some embodiments, the file may be stored directly in a database (e.g., database 114). However, storing large files (e.g., videos, images, etc.) in a database (e.g., database 114) may not advantageous. For example, storing large files in a database may increase the database cost and the database limits. Additionally, storing large files in a database may slow down database queries and may make storing and serving files more complex.

At block 606, the file location in cloud storage 616 may be saved in a database (e.g., database 114).

At block 608, one or more requests from one or more users may be received. In some embodiments, the one or more users may make the file request (e.g., a selected synchronized time-lapse video or a selected electronic card) using user devices 118-A, 118B, as described in detail above with respect to FIG. 2. To locate the file from the database 114, the one or more users' requests may be sent to the computing device 112, via a network (e.g., network 116), where the database 114 provides the computing device 112 with the file location.

At block 610, when the file is ready to be served to one or more recipient devices (e.g., recipient devices 120-A, 120-B, 120-C, 120-D), the computing device 112 may serve the file, via the network 116, to the one or more recipient devices 120-A, 120-B, 120-C, 120-D. In some embodiments, when the file is ready to be served to the one or more recipient devices 120-A, 120-B, 120-C, 120-D, the computing device 112 may retrieve the file from the cloud storage 616, from the location previously determined at block 608 and serve the file to the recipient devices 120-A, 120-B, 120-C, 120-D via the network 116. After reading this description, it will be apparent to one skilled in the art how to implement the method 600 using computing devices 112 that include other systems or architectures.

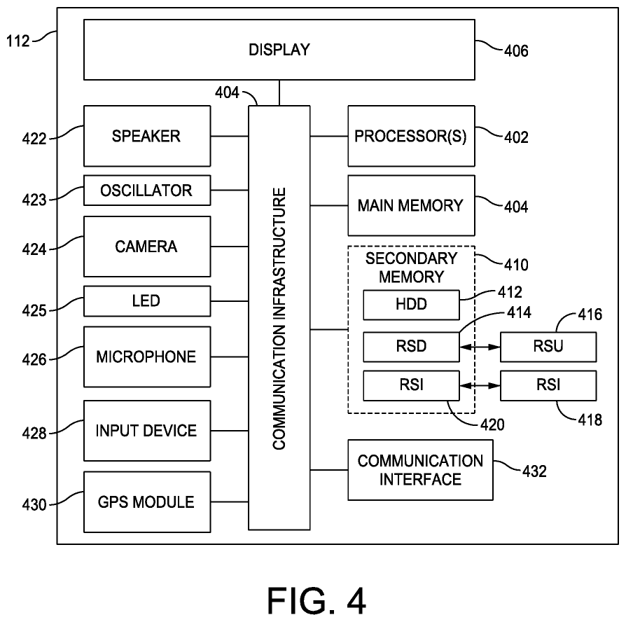

FIG. 4 is a block diagram of one example of a computing device 112 in accordance with some embodiments. As shown in FIG. 4, computing device 112 may include one or more processors, such as processor(s) 402. Processor(s) 402 may be any central processing unit (“CPU”), microprocessor, micro-controller, or computational device or circuit for executing instructions. Processor(s) 402 may be connected to a communication infrastructure 404 (e.g., a communications bus, crossover bar, or network). Various software embodiments are described in terms of this exemplary computing device 112. It will be apparent to one skilled in the art how to implement the method 200 using computing devices 112 that include other systems or architectures.

Computing device 112 may include a display 406 that displays graphics, video, text, and other data received from the communication infrastructure 404 (or from a frame buffer not shown) to an operator (e.g., an administrator of the service using computing device 112, for example). Examples of such displays 406 may include, but are not limited to, LCD screens, OLED display, capacitive touch screen, and a plasma display, to name a few possible displays. Computing device 112 also may include a main memory 404, such as a random access (“RAM”) memory, and may also include a secondary memory 410. Secondary memory 410 may include a more persistent memory such as, for example, a hard disk drive (“HDD”) 412 and/or removable storage drive (“RSD”) 414, representing a magnetic tape drive, an optical disk drive, solid state drive (“SDD”), or the like. In some embodiments, removable storage drive 414 may read from and/or write to a removable storage unit (“RSU”) 416 in a manner that is understood by one skilled in the art. Removable storage unit 416 may represent a magnetic tape, optical disk, or the like, which may be read by and written to by removable storage drive 414. As will be understood by one skilled in the art, the removable storage unit 416 may include a tangible and non-transient machine readable storage medium having stored therein computer software and/or data.

In some embodiments, secondary memory 410 may include other devices for allowing computer programs or other instructions to be loaded into computing device 112. Such devices may include, for example, a removable storage unit (“RSU”) 418 and a corresponding interface (“RSI”) 420. Examples of such units 418 and interfaces 420 may include a removable memory chip (such as an erasable programmable read only memory (“EPROM”)), programmable read only memory (“PROM”)), secure digital (“SD”) card and associated socket, and other removable storage units 418 and interfaces 420, which allow software and data to be transferred from the removable storage unit 418 to computing device 112.

Computing device 112 may also include a speaker 422, an oscillator 423, a camera 424, a light emitting diode (“LED”) 425, a microphone 426, an input device 428, and a global positioning system (“GPS”) module 430. Examples of input device 428 include, but are not limited to, a keyboard, buttons, a trackball, or any other interface or device through which an operator may input data. In some embodiments, input device 428 and display 406 may be integrated into the same device. For example, display 406 and input device 428 may be touchscreen through which a user uses a finger, pen, or stylus to input data into computing device 112.

Computing device 112 may also include one or more communication interfaces 432, which allows software and data to be transferred between computing device 112 and external devices such as, for example, another mobile device or computer (e.g., user devices 118-A, 118-B and recipient devices 120-A, 120-B, 120-C, 120-D), and other devices that may be locally or remotely connected to computing device 112. Examples of the one or more communication interfaces 432 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 432 may also include a wireless interface configured for short range communication, such as near field communication (“NFC”), Bluetooth, or other interface for communication via another wireless communication protocol. One of ordinary skill in the art will understand that user devices 118 and recipient devices 120 may include some or all components of computing device 112 and/or additional components not illustrated in FIG. 4.

Software and data transferred via the one or more communications interfaces 432 are in the form of signals, which may be electronic, electromagnetic, optical, or other signals capable of being received by communications interfaces 432. These signals may be provided to communications interface 432 via a communications path or channel. The channel may be implemented using wire or cable, fiber optics, a telephone line, a cellular link, a radio frequency (“RF”) link, or other communication channels.

In this document, the terms “non-transient computer program medium” and “non-transient computer readable medium” may refer to media such as removable storage units 416, 418, or a hard disk installed in hard disk drive 412. These computer program products may provide software to computing device 112. Computer programs (also referred to as “computer control logic”) may be stored in main memory 404 and/or secondary memory 410. Computer programs may also be received via the one or more communications interfaces 432. Such computer programs, when executed by a processor(s) 402, enable the computing device 112 to perform the features of the method 200 discussed herein.

In an embodiment where the methods disclosed herein may be implemented using software, the software may be stored in a computer program product and loaded into a computing device (e.g., computing device 112, user device 118, recipient device 12) using removable storage drive 414, hard drive 412, and/or communications interface 432. The software, when executed by a processor(s) 402, may cause the processor(s) 402 to perform the functions of the methods described herein. In another embodiment, the methods may be implemented primarily in hardware using, for example, hardware components such as application specific integrated circuits (“ASICs”). Implementation of the hardware state machine so as to perform the functions described herein will be understood by persons skilled in the art. In yet another embodiment, the methods may be implemented using a combination of both hardware and software.

Although the systems and methods have been described in terms of exemplary embodiments, they are not limited thereto. Rather, the appended claims should be construed broadly, to include other variants and embodiments of the systems and methods, which may be made by those skilled in the art without departing from the scope and range of equivalents of the systems and methods.

What is claimed is:

1. A system, comprising:
an image capture device;
an intervalometer coupled to the image capture device for controlling an interval at which the image capture device captures an image of one or more objects; and
a computing device including a processor, the processor configured to:
combine a plurality of images captured by the image capture device and a selected audio file into a first file, and
store the first file in a non-transitory, machine readable storage medium that is accessible via a network such that the first file may be requested via the network.

2. The system of claim 1, wherein the non-transitory, machine readable storage medium includes a database.

3. The system of claim 1, wherein the one or more objects is one or more flowers.

4. The system of claim 3, wherein the plurality of images are captured by the image capture device as the one or more flowers bloom.

5. The system of claim 1, wherein the processor is configured to pair the first file with a second file comprising an electronic card.

6. The system of claim 5, wherein the processor is configured to transmit the second file and a link to the first file to one or more recipient devices.

7. The system of claim 1, wherein the image capture device is a DSLR camera or mirrorless camera.

8. The system of claim 1, wherein the intervalometer is a part of the image capture device or on a mobile application that is connected wirelessly to the image capture device.

9. The system of claim 1, wherein the intervalometer is coupled to the image capture device by a wired connection.

10. A method comprising:
receiving a plurality of images from an image capture device coupled to an intervalometer;
combining the plurality of images and a selected audio file into a first file;
saving the first file in a cloud server;
storing the first file's location in the cloud server in a database that is accessible via a network;
pairing the first file with a second file indicated by one or more user selections received via the network; and
transmitting the second file and a link to the first file to one or more recipient devices via the network.

11. The method of claim 10, wherein the plurality of images capture one or more flowers blooming.

12. The method of claim 10, wherein the second file comprises an electronic card.

13. The method of claim 11, wherein the plurality of images are captured by the image capture device.

14. The method of claim 10, wherein a computing device including a processor performs the combining the plurality of images and the selected audio file into the first file.
